(19) United States
(12) Patent Application Publication
(10) Pub. No.: US 2025/0034340 A1
(43) Pub. Date: Jan. 30, 2025

(54) MASTERBATCH COMPOSITIONS

(71) Applicant: Dow Global Technologies LLC, Midland, MI (US)

(72) Inventors: Rony S.L. Vanspeybroeck, Bellem (BE); Johan Bats, Terneuzen (NL); Gillis Nijssen, Terneuzen (NL)

(73) Assignee: Dow Global Technologies LLC, Midland, MI (US)

(21) Appl. No.: 18/718,956

(22) PCT Filed: Nov. 29, 2022
(86) PCT No.: PCT/US2022/080571

§ 371 Date: Jun. 12, 2024

Related U.S. Application Data
(60) Provisional application No. 63/265,501, filed on Dec. 16, 2021.

(51) Int. Cl. C08J 3/22; C08K 5/098

(52) U.S. Cl. CPC C08J 3/226; C08K 5/098; C08J 2323/04; C08J 2323/10

(57) ABSTRACT

Masterbatch compositions that contain polyolefin polymer and additives can be made with high levels of additives and low dust formation, if the additives include at least 2 weight percent of the metal salt of a fatty acid.

### TECHNICAL FIELD

This invention relates to masterbatch compositions for polyolefin polymers, and processes for using them.

### BACKGROUND

Polyolefin polymers are commonly mixed with additives before they are molded or extruded into their intended shaped articles. Known examples of useful additives include antioxidants, light stabilizers, flame retardants, colorants and processing agents such as lubricants, plasticizers, slip agents and antiblock agents. The final concentration of the additives (other than fillers and colorants) is usually from 100 ppmw to 5000 ppmw of the blended composition.

It is difficult to accurately add and homogeneously blend additives into the polyolefin polymer in low concentrations. To make the process easier, additive packages are first blended with the polymer in higher concentrations to form masterbatches. For example, the article “An Overview—Masterbatch” describes masterbatches that commonly contain 40-65 percent additives, but at the outer limit may contain 15-80 percent additive (https://www.plastics-technology.com/articles/an-overview-masterbatch-plastics-technology). The masterbatches are generally formed into pellets like the resin they will be added to. The masterbatch pellets are easy to meter into extrusion equipment in precise quantities and easy to disperse homogenously into the polymer melt in the equipment.

Masterbatch pellets are desirably tough (rather than brittle) so that they can be transported and used without forming excessive dust. Dust from additives used in the masterbatch can create a fire or explosion hazard or can create a breathing hazard. Masterbatch compositions may be transported in bags and conveyed on site using pneumatic conveyors. The transport and handling may subject pellets to repeated physical shocks that may create dust in brittle pellets.

Masterbatches are also desirably inexpensive. The formation of masterbatches requires extra processing steps for the additives, which add cost to the masterbatch.

### SUMMARY

The cost of masterbatch compositions may be reduced by increasing the concentration of additives and reducing the concentration of polymer in the masterbatch. Increasing the concentration of additives in the masterbatch reduces the overall quantity of masterbatch that is compounded and used, thereby reducing compounding costs. However, reducing the concentration of polymer risks increasing the brittleness of the masterbatch pellet and creating dust. The formation of dust can be minimized by including the metal salt of a fatty acid, such as calcium stearate, among the additives in the masterbatch. Metal salts of fatty acids are commonly added to polymers as lubricants, release agents and/or acid scavengers; they can also improve the toughness of the masterbatch pellet.

One embodiment of the present invention is a masterbatch composition comprising (i) from 2 weight percent to 30 weight percent of a polyolefin polymer and (ii) from 98 weight percent to 70 weight percent additives for polyolefin polymer formulations, wherein:
a. The additives include at least 2 weight percent of the metal salt of a fatty acid;
b. The additives include less than 70 weight percent filler; and
c. All weight percentages are based on the overall weight of the masterbatch composition.

A second embodiment of the present invention is a process to make polyolefin polymer formulations comprising the step of coextruding a polyolefin polymer with the masterbatch composition of the present invention under conditions to homogeneously blend the masterbatch composition into polyolefin polymer.

A third embodiment of the present invention is a method to convey the masterbatch composition of the present invention in a facility, wherein the masterbatch composition is conveyed using pneumatic equipment in an air atmosphere.

### DETAILED DESCRIPTION

The masterbatch compositions of this invention contain a polyolefin polymer and additives.

### Polyolefin Polymers

Polyolefin polymers and processes to make them are well known. They are typically made by polymerizing ethylene and/or propylene monomer, optionally with a minor amount of a comonomer.

In some embodiments, the polyolefin polymer is a polyethylene homopolymer or copolymer, which contains at least 50 mole percent repeating units derived from ethylene, or at least 80 mole percent or at least 85 mole percent ethylene or at least 90 mole percent, and at most 100 percent repeating units derived from ethylene. In polyethylene copolymers, common examples of suitable comonomer units include repeating units derived from butylene, pentene, hexene, heptane and/or octene, although other unsaturated olefin comonomers are also suitable.

In some embodiments, the polyolefin polymer is a polypropylene homopolymer or copolymer, which contains at least 50 mole percent repeating units derived from propylene, or at least 80 mole percent or at least 85 mole percent ethylene or at least 90 mole percent, and at most 100 percent repeating units derived from propylene. In polypropylene copolymers, comonomer units are commonly derived from ethylene, although other unsaturated olefin comonomers are also suitable.

The masterbatch composition contains from 2 weight percent to 30 weight percent of the polyolefin polymer. In some embodiments, it contains at least 3 or 4 or 5 or 6 or 7 or 8 or 9 or 10 weight percent polyolefin polymer. In some embodiments, it contains at most 25 or 22 or 20 or 18 or 15 or 12 or 10 weight percent polyolefin polymer. In some embodiments, the masterbatch composition contains less than 20 weight percent polyolefin polymer. All weight percentages are based on the total weight of the masterbatch composition.

### Additives

Additives for polyolefin polymers are well known. Examples of common additives include antioxidants, light stabilizers, acid scavengers, processes aids (such as lubricants, rheology control agents, mold release agents, antiblock additives and slip agents), antistatic additives, flame retardants, colorants and fillers. The preferred selection of additives will depend on the polyolefin polymer that the masterbatch composition will be blended with, and on the intended use of the final product.

Many potential additives can serve more than one purpose. For example, calcium stearate can serve as both a lubricant and an acid scavenger in polyolefin, and hindered amine antioxidants are also frequently used in light stabilizer packages. Fatty amides may be useful as lubricants, slip agents, and antiblock additives.

Additives for polyolefin polymers are described in numerous publications, such as the pamphlet: Tolinski, “Additives for Polyolefins. Getting the Most out of Polypropylene, Polyethylene and TPO (Second Edition)” published by the Plastics Design Library in 2015. Persons who work with other polyolefin polymers can readily find references that list the proper additives and proportions for their polymer and its intended use.

The following examples of additives are non-limiting. They do not exclude the presence of other additives in the masterbatch composition. Further, except for the metal salt of a fatty acid, masterbatch compositions of this invention are not required to contain any of the examples listed below. The masterbatch composition may contain all the examples listed below, some of the examples listed below or none of the examples listed below except for the metal salt of a fatty acid.

Antioxidants are commonly divided into primary antioxidants (radical scavengers) and secondary antioxidants (hydroperoxide scavengers).

Examples of common primary antioxidants include:
Hindered phenols, such as pentaerythrityl tetrakis(3-(3,5-di-tert-butyl-4-hydroxyphenol) propionate), which is commercially available under the name of Irganox 1010, or octadecyl 3-(3,5-di-tert-butyl-4-hydroxyphenyl) propionate, which is commercially available under the name Irganox 1076.
Hindered amines, such as the polyamines that are commercially available under the name Chimassorb 944 or Chimassorb 2020.
Vitamin E, either natural or artificial;
Lactones.

Examples of common secondary antioxidants include:
Phosphites such as tris(2,4-di-tert-butylphenyl) phosphite, which is commercially available under the name IRGAFOS™ 168, or tris(nonylphenyl) phosphite.
Thioesters such as distearyl thio dipropionate.

Light stabilizers commonly work by blocking light (especially ultraviolet light) or absorbing damaging light and emitting the energy in a less-damaging form. Examples of common light stabilizers include:
Carbon black;
Pigments such as titanium dioxide;
Benzophenones such as 2-hydroxy-4-n-octoxybenzophenone, which is commercially available as Chimassorb 81 and Cyasorb UV-531;
Benzotriazoles such as 2-(5-chloro-2H-benzotriazol-2-yl)-6-(1,1-dimethylethyl)-4-methyl phenol, which is commercially available as Tinuvin 326;
Cyanoacrylates such as 1, 3-bis-((2′-cyano-3′, 3′-diphenylacryloyl)oxy)-2, 2-bis-(((2′-cyano-3′, 3′-diphenylacryloyl)oxy) methyl)-propane, which is commercially available as Uvinul 3030; and
Phenyl- or aryl esters, such as benzoic acid, 3, 5-(1,1-dimethylethyl)-, 2,4-bis (1, 1-dimethyethyl) phenyl ester, which is commercially available as Tinuvin 120.

Some primary antioxidants described above may be used in connection with the light stabilizer, to clean up free radicals that may be created with the light stabilizer absorbs light. The hindered amine stabilizers are sometimes used for this purpose.

Examples of acid scavengers include hydrotalcites (such as those commercially available under the name DHT-4A), metal stearates (such calcium stearate and zinc stearate), and zinc oxide.

Examples of processing aids include:
Lubricants. Some lubricants are metal salts of fatty acids, such as metal stearates like calcium stearate and zinc stearate. Some lubricants are fatty amides, esters, acids or alcohols, such as glycerol monostearate, erucamide, oleamide, and ethylene bis(stearamide). Some lubricants are polymers such as silicones, fluoropolymers and polyolefin plastomers or oligomers.
Rheology control agents. For example, peroxides may be added to polypropylene to lower viscosity during molding. Other examples include Polymer Processing Aids, such as 3M Dynamar™ products.
Mold release agents. Mold release agents reduce adhesion of a polyolefin polymer to a mold. Examples of mold release agents include fatty acids or esters like glycerol monostearate; amides like erucamide and oleamide; hydrocarbon microcrystalline waxes; and partially oxidized polyethylene.
Slip agents. Slip agents lower friction between a polyolefin polymer and processing equipment. Examples of slip agents include fatty acid amides like erucamide, oleamide, stearamide, ethylene bis-stearamide and stearyl stearamide.
Antiblock agents. Antiblock agents prevent layers of polyolefin polymer from sticking to each other. Examples of antiblock agents include inorganic materials that roughen the surface of a film, like diatomaceous earth, silica or talc, and fatty acid amides like behanamide, erucamide or stearamide.

Examples of antistatic additives include:
some non-ionic compounds such a glycerol esters like glycerol monostearate, lauric diethanolamide (commercially available as Chemstat LD-100) and ethoxylated amines (commercially available as Chemstat 122).
Dissipative polymers such as polyether block amides and ethylene ionomers.
Conductive fillers such as carbon black, graphene, graphite, metal particles and coated inorganic particles.
Conductive fibers such as metal fibers or carbon fibers.

Examples of flame retardants include:
Brominated or chlorinated compounds such as Decabromodiphenyl ether (commercially available as FR1210), Tetrabromobisphenol A bis(2,3-dibromopropyl) ether (commercially available as FR-720) and chlorinated paraffin (commercially available as Chlororez 700).
Phosphate flame retardants, which typically contain an acid source such as ammonium polyphosphate (commercially available as Exolit AP-570), a cross-linker such as pentaerythritol and a foaming agent such as melamine

Examples of colorants include:
White colorants such as titanium dioxide, zinc sulfide and barium sulfate.
Black colorants such as carbon black, copper chromate and brown hematite.
Colored pigments such as azo dyes for a wide range of colors, iron oxide or quinacridone for red, cadmium sulfide for yellow, chromium (III) oxide for green or cobalt aluminate for blue.
Metal flakes to give a metallic appearance.
Mica flakes to add a pearlescent or speckled appearance.

Examples of common fillers include calcium carbonate, talc, mica, wollastonite, silica and glass spheres. Many common fillers have average particle sizes of 1-100 microns or 2-50 microns.

Masterbatch compositions of this invention contain from 70 weight percent to 98 weight percent additives. In some embodiments, the concentration of additives may be at least 75 weight percent or at least 78 weight percent or at least 80 weight percent or at least 82 weight percent or at least 85 weight percent or at least 88 weight percent or at least 90 weight percent. In some embodiments, the concentration of additives may be at most 97 or 96 or 95 or 94 or 93 or 92 or 91 or 90 weight percent. In some embodiments, the concentration of additives is more than 80 weight percent. All weight percentages are based on the weight of the masterbatch composition.

In masterbatch compositions of this invention, the additives include at least 2 weight percent of a metal salt of a fatty acid. In some embodiments, the concentration of metal fatty acid salt is at least 5 weight percent or at least 8 weight percent or at least 10 weight percent or at least 15 weight percent. In some embodiments, the concentration of metal fatty acid salt is at most 30 weight percent or at most 28 weight percent or at most 26 weight percent. All weight percent are based on the total weight of the masterbatch composition.

Examples of suitable metals for the metal salt of a fatty acid include calcium, zinc, sodium, potassium, magnesium, lithium, copper and silver. In some embodiments the metal is calcium, and in some embodiments the metal is zinc.

Examples of suitable fatty acids for the metal salt include acids that contain at least 12 carbon atoms or at least 14 carbon atoms or at least 16 carbon atoms or at least 18 carbon atoms. Examples of suitable fatty acids for the metal salt include acids that contain at most 30 carbon atoms or at most 26 carbon atoms or at most 22 carbon atoms or at most 20 carbon atoms. Suitable fatty acids may be saturated, monounsaturated, or polyunsaturated. In some embodiments, the fatty acid may be myristic acid or palmitic acid or stearic acid or arachidic acid or behenic acid. In some embodiments, the fatty acid is stearic acid.

In some embodiments, the metal salt of a fatty acid is calcium stearate or zinc stearate.

Masterbatch compositions of this invention contain less than 70 weight percent filler. In some embodiments, the masterbatch composition contains no more than 50 weight percent filler, or no more than 40 weight percent filler or no more than 30 weight percent filler or no more than 20 weight percent filler. Some embodiments contain essentially no filler (0 weight percent).

In some embodiments, the masterbatch composition contains no more than 70 weight percent colorant, or no more than 50 weight percent colorant or no more than 30 weight percent colorant or no more than 20 weight percent colorant. Some embodiments contain essentially no colorant (0 weight percent).

In some embodiments, the masterbatch composition contains no more than 70 weight percent calcium carbonate, or no more than 50 weight percent calcium carbonate or no more than 30 weight percent calcium carbonate or no more than 20 weight percent calcium carbonate. Some embodiments contain essentially no calcium carbonate (0 weight percent).

In some embodiments, the aggregate concentration of filler (including calcium carbonate) and colorant in the masterbatch composition is no more than 50 weight percent c or no more than 30 weight percent or no more than 20 weight percent. Some embodiments contain essentially no filler or colorant.

Masterbatch compositions of this invention can be made by coextruding the ingredients under conditions suitable to melt the polyolefin polymer and homogeneously blend the ingredients. Suitable extruders and their use are known. In some embodiments, the cylinder temperature for extruding masterbatches that contain polyethylene is between 175° C. and 270° C. or between 180° C. and 210° C. In some embodiments, the cylinder temperature for extruding masterbatches that contain polypropylene is between 180° C. and 250° C. or between 200° C. and 230° C.

After the ingredients are homogeneously blended, the molten masterbatch may be extruded and formed into shapes that are useful for a masterbatch. For example, the masterbatch may be formed into pellets by extruding as strands, cooling the strands and then chopping the strands into pellets. Some masterbatch pellets may have a diameter between 1 mm and 5 mm and may have a length between 1 mm and 10 mm.

In many embodiments, masterbatch pellets of the present invention after handling contain no more than 500 ppm dust by weight, or no more than 400 ppm dust, or no more than 300 ppm dust, or no more than 200 ppm dust, or no more than 150 ppm dust. “Dust” means particles in the masterbatch that can pass through a 500 μm sieve. The low dust content in masterbatch pellets of the present invention permits the pellets to be transported and handled in pneumatic equipment that uses air as a medium, rather than nitrogen as a medium. Air pneumatic equipment is less expensive to install and operate than nitrogen pneumatic equipment but may have a higher risk of fire when the transported material contains high levels of dust.

Masterbatch compositions of the present invention can blended with a molten polyolefin polymer (“base polymer”) by known methods, to disperse their additives throughout the base polymer. In some embodiments, the masterbatch composition is homogeneously blended with the base polymer in an extruder, and the resulting blend is extruded to form useful shaped articles, such as films or molded articles.

The description of potential base polymers is similar to the description of polyolefin polymer that is used in the masterbatch composition. The polyolefin polymer in the masterbatch composition should be compatible with the base polymer, so that the two polymers can blend homogeneously together. In some embodiments, the polyolefin polymer in the masterbatch composition is different from the base polymer but compatible with the base polymer. In some embodiments, the polyolefin polymer in the masterbatch composition and the base polymer are similar classes of polymers, such as both are polyethylene homopolymers or are polyethylene copolymers or are polypropylene homopolymers or are polypropylene copolymers. In some embodiments, the weight average molecular weight of the polyolefin polymer in the masterbatch composition is from 25 percent to 400 percent of the weight average molecular weight of the base polymer, or from 35 percent to 300 percent or from 50 percent to 200 percent.

The ratio of masterbatch to base resin varies depending on the additive content of the masterbatch and the desired additive content of the base resin. Persons familiar with compounding of polyolefin polymers can easily calculate the desired amount. In some embodiments, the masterbatch may be blended with the base resin in a ratio from 0.01 to 5 weight parts of masterbatch per 100 weight parts of base resin, although higher levels may be used if the masterbatch contains fillers or colorants.

Some embodiments of the invention are illustrated by the following non-limiting examples:

### EXAMPLES

Sample masterbatches are made by melt co-extruding polyethylene resin (DOWLEX™ 2035G), calcium stearate, Irgafos 168 additive and Irganox 1076 in the proportions shown in Table 1 with an extrusion zone temperature between 210° C. and 260° C. Some samples are comparative and leave out the polyethylene resin or the calcium stearate.

Each of the samples is passed three times through a KICE Multi-Aspirator 6DT4-1 to simulate handling. Recovered material is sieved using a 500 μm screen and a 63 μm screen using a vibrating sieve for 10 minutes at 20° C. under lab controlled conditions. The quantity of dust recovered from the sieving is listed in Table 1, as parts-per-million-by-weight (ppm) based on the weight of each sample. The results show that the inventive examples have less dust than the comparative examples.

TABLE 1

| | Inventive Examples | | | | | | Comparative Examples | | | |
|---|---|---|---|---|---|---|---|---|---|---|
| Sample Number | i79 | i03 | i55 | i65 | i66 | i67 | c38 | c33c | c33e | c03 |
| Polyethylene (wt. %) | 24 | 10 | 15.0 | 20.0 | 10.0 | 30 | 15 | 20 | 20 | 0 |
| Calcium Stearate (wt. %) | 16 | 26 | 24.2 | 22.8 | 25.7 | 20 | 0 | 0 | 0 | 29 |
| Irgafos 168 (wt. %) | 48 | 51 | 12.2 | 11.4 | 12.9 | 40 | 68 | 64 | 64 | 57 |
| Irganox 1076 (wt. %) | 12 | 13 | 48.6 | 45.8 | 51.5 | 10 | 17 | 16 | 16 | 14 |
| Dust collected 63 μm | 99 | 118 | 274 | 193 | 230 | 176 | 957 | 1031 | 474 | 888 |
| Sieve (ppm) | | | | | | | | | | |
| Dust passing through | 36 | 5 | 7 | 4 | 6 | 34 | 487 | 647 | 250 | 256 |
| 63 μm Sieve (ppm) | | | | | | | | | | |
| Total dust less than | 134 | 123 | 280 | 196 | 236 | 210 | 1444 | 1678 | 724 | 1144 |
| 500 μm | | | | | | | | | | |

1. A masterbatch composition comprising (i) from 2 weight percent to 30 weight percent of a polyolefin polymer and (ii) from 98 weight percent to 70 weight percent additives for polyolefin polymer formulations, wherein:
a) The additives include at least 2 weight percent of the metal salt of a fatty acid;
b) The additives include less than 70 weight percent filler; and
c) All weight percentages are based on the overall weight of the masterbatch composition.

2. The masterbatch composition of claim 1, wherein the composition contains no more than 25 weight percent polyolefin polymer and at least 75 weight percent additives.

3. The masterbatch composition of claim 1, wherein the composition contains less than 20 weight percent polyolefin polymer and more than 80 weight percent additives.

4. The masterbatch composition of claim 1, wherein the composition contains no more than 15 weight percent polyolefin polymer.

5. The masterbatch composition of any of claim 1, wherein the composition contains at least 8 weight percent polyolefin polymer.

6. The masterbatch composition of claim 1, wherein the polyolefin polymer comprises polyethylene homopolymer or copolymer.

7. The masterbatch composition of claim 1, wherein the polyolefin polymer comprises polypropylene homopolymer or copolymer.

8. The masterbatch composition of claim 1, wherein the composition comprises at least 8 weight percent metal salt of a fatty acid and at most 30 weight percent metal salt of a fatty acid.

9. The masterbatch composition of claim 1, wherein the metal salt of a fatty acid comprises a metal stearate.

10. The masterbatch composition of claim 1, wherein the metal salt of a fatty acid comprises a calcium stearate or zinc stearate.

11. The masterbatch composition of claim 1, wherein the composition comprises in aggregate no more than 50 weight percent filler and colorant.

12. The masterbatch composition of claim 1, wherein the composition contains essentially no filler or colorant.

13. The masterbatch composition of claim 1, wherein the composition is in the form of a pellet.

14. A method to convey the masterbatch composition in claim 1 in a facility, wherein the masterbatch composition is conveyed using pneumatic equipment in an air atmosphere.

15. A process to make polyolefin polymer formulations comprising the step of coextruding a polyolefin polymer with the masterbatch composition in claim 1 under conditions to homogeneously blend the masterbatch composition into polyolefin polymer.
